(19) United States
(12) Patent Application Publication
(10) Pub. No.: US 2025/0309940 A1
(43) Pub. Date: Oct. 2, 2025

(54) Ultra-wideband circuit

(71) Applicant: REALTEK SEMICONDUCTOR CORPORATION, HSINCHU (TW)

(72) Inventor: CHEN ZHU, Suzhou (CN)

(21) Appl. No.: 18/979,685

(22) Filed: Dec. 13, 2024

(30) Foreign Application Priority Data
Mar. 27, 2024 (CN) 202410362438.8

(51) Int. Cl. H04B 1/719

(52) U.S. Cl. CPC H04B 1/719

(57) ABSTRACT

An ultra-wideband (UWB) circuit includes a first pin, a second pin, a control register, a baseband circuit, a switch, a transmission circuit, a receiving circuit, a first low noise amplifier (LNA), and a second LNA. The control register stores a plurality of control values. The baseband circuit is coupled to the control register and configured to set the control values. The switch is coupled to the first pin. The transmission circuit is coupled to the control register and the switch and operates according to one of the control values. The receiving circuit is coupled to the control register and operates according to one of the control values. The first LNA is coupled to the switch and the receiving circuit. The second LNA is coupled to the second pin and the receiving circuit.

### BACKGROUND OF THE INVENTION

### 1. Field of the Invention

The present invention generally relates to an ultra-wideband (UWB) circuit, and, more particularly, to a UWB circuit that supports UWB ranging and radar detection.

### 2. Description of Related Art

Reference is made to FIG. 1, which shows a schematic diagram of the conventional vehicle ultra-wideband (UWB) ranging and radar detection. The car 100 is equipped with 5 ranging anchors 101 to 105, and a radar detector 110 for the kick-activated tailgate. The ranging anchors 101 to 105 and the radar detector 110 all use UWB technology. Each ranging anchor 101 to 105 requires a UWB circuit.

Reference is made to FIG. 2, which is a functional block diagram of the conventional radar detector 110. The UWB circuit 210 and the UWB circuit 220 cooperate to detect an object 201. The UWB circuit 210 and the UWB circuit 220 are respectively coupled to an antenna 203 and an antenna 205. The UWB circuit 210 includes a transmission circuit 212, a receiving circuit 214, and a switch 216. The UWB circuit 220 includes a transmission circuit 222, a receiving circuit 224, and a switch 226.

The UWB circuit 210 and the UWB circuit 220 both have a structure of one transmission circuit and one receiving circuit. Since the UWB circuit 210 and the UWB circuit 220 each cannot transmit and receive signals simultaneously, the radar detector 110 requires two UWB circuits, and signal synchronization is required between the UWB circuit 210 and the UWB circuit 220. Because the radar detector 110 requires two UWB circuits, the cost of the car 100 increases.

In addition, if the radar detector 110 shares a UWB circuit with the ranging anchor 104 and/or the ranging anchor 105 to save costs, the antenna 203 and the antenna 205 must be omnidirectional antennas, which makes the radar detector 110 more susceptible to interference and less accurate.

### SUMMARY OF THE INVENTION

In view of the issues of the prior art, an object of the present invention is to provide an ultra-wideband (UWB) circuit, so as to make an improvement to the prior art.

According to one aspect of the present invention, an ultra-wideband (UWB) circuit is provided. The UWB circuit includes: a first pin; a second pin; a control register storing a plurality of control values; a baseband circuit coupled to the control register and configured to set the plurality of control values; a switch coupled to the first pin; a transmission circuit coupled to the control register and the switch and configured to operate according to one of the plurality of control values; a receiving circuit coupled to the control register and configured to operate according to one of the plurality of control values; a first low noise amplifier (LNA) coupled to the switch and the receiving circuit; and a second LNA coupled to the second pin and the receiving circuit.

The technical means embodied in the embodiments of the present invention can solve at least one of the problems of the prior art. Therefore, compared to the prior art, the present invention can reduce the circuit area and improve performance.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows a schematic diagram of the conventional ultra-wideband (UWB) ranging and radar detection for vehicles.

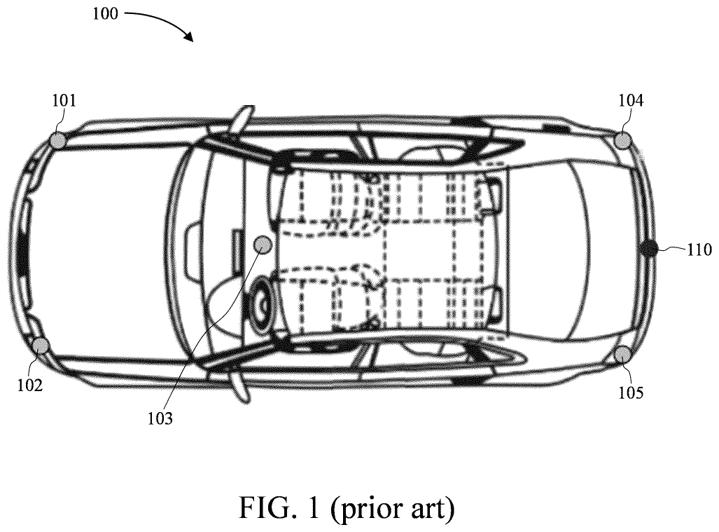

FIG. 2 is a functional block diagram of a conventional radar detector.

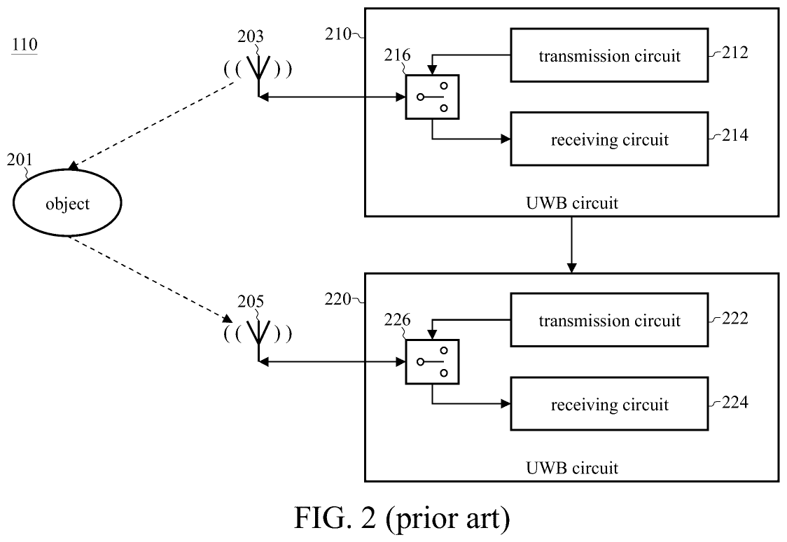

FIG. 3 is a functional block diagram of the UWB circuit according to an embodiment of the present invention.

FIG. 4 is a functional block diagram of the UWB circuit according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an ultra-wideband (UWB) circuit. On account of that some or all elements of the UWB circuit could be known, the detail of such elements is omitted provided that such detail has little to do with the features of this disclosure, and that this omission nowhere dissatisfies the specification and enablement requirements. A person having ordinary skill in the art can choose components or steps equivalent to those described in this specification to carry out the present invention, which means that the scope of this invention is not limited to the embodiments in the specification.

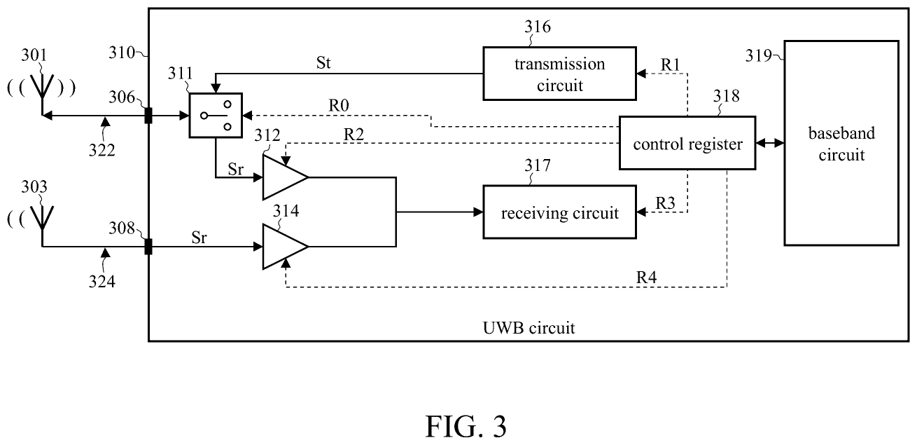

Reference is made to FIG. 3, which is a functional block diagram of the UWB circuit according to an embodiment of the present invention. The UWB circuit 310 includes a switch 311, a low noise amplifier (LNA) 312, an LNA 314, a transmission circuit 316, a receiving circuit 317, a control register 318, and a baseband circuit 319, which are coupled to each other. In addition, the UWB circuit 310 further includes a pin 306 and a pin 308. The pin 306 is coupled to the antenna 301 and the switch 311. The pin 308 is coupled to the antenna 303 and the LNA 314. The antenna 301 is an omnidirectional antenna, while the antenna 303 is a directional antenna. In some embodiments, the UWB circuit 310 may be a part of a system on a chip (SoC).

The baseband circuit 319 controls the UWB circuit 310 to operate in a UWB ranging mode or a radar detection mode by setting the control values of the control register 318. The switch 311, the transmission circuit 316, the LNA 312, the receiving circuit 317, and the LNA 314 operate according to the control values. As shown in FIG. 3, in some embodiments, the control register 318 contains five control values R0 to R4. The control value R0 corresponds to the switch 311. The control value R1 corresponds to the transmission circuit 316. The control value R2 corresponds to the LNA 312. The control value R3 corresponds to the receiving circuit 317. The control value R4 corresponds to the LNA 314.

In the radar detection mode, the control values R0 to R4 are respectively the first value (e.g., logic 1), the first value, the second value (e.g., logic 0), the first value, and the first value. The control value R1 and the control value R3 being the first values indicate that the transmission circuit 316 and the receiving circuit 317 are enabled. The control value R0 being the first value indicates that the switch 311 is switched to the transmission circuit 316, so that the transmission circuit 316 can transmit the RF signal St through the antenna 301. The control value R2 being the second value indicates that the LNA 312 is disabled. The control value R4 being the first value indicates that the LNA 314 is enabled. In this way, the UWB circuit 310 receives the reflected signal Sr from the object through the path of the antenna 303→the LNA 314→the receiving circuit 317, to achieve the function of radar detection. Since the UWB circuit 310 receives signals through the directional antenna 303, the radar detection of the UWB circuit 310 can avoid interference signals from other directions, enhancing the anti-interference capability of the radar detection. In addition, generally speaking, the gain of a directional antenna (5 to 10 dBi) is higher than the gain of an omnidirectional antenna (approximately 2.15 dBi).

In the UWB ranging mode, the control values R1 to R4 are the first value, the first value, the first value, and the second value, respectively, so as to enable the transmission circuit 316, the LNA 312, and the receiving circuit 317, and disable the LNA 314. The baseband circuit 319 first controls the control value R0 to be the first value (where the switch 311 is switched to the transmission circuit 316), so that the transmission circuit 316 can transmit the RF signal St through the antenna 301, and then controls the control value R0 to be the second value (where the switch 311 is switched to the receiving circuit 317), so that the UWB circuit 310 receives the RF signal St from another UWB circuit through the path of the antenna 301→the LNA 312→the receiving circuit 317, in order to achieve the function of UWB ranging. Because in the UWB ranging mode, the UWB circuit 310 receives signals from an anchor through the omnidirectional antenna 301, the UWB ranging can be more accurate.

As the operating principles of the LNA 312 and the LNA 314 are well known to people having ordinary skill in the art, further elaboration is omitted for brevity.

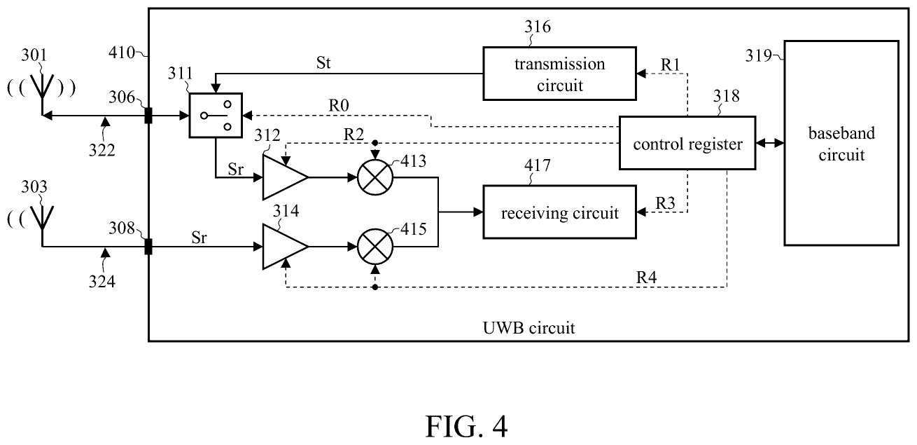

Reference is made to FIG. 4, which is a functional block diagram of the UWB circuit according to another embodiment of the present invention. The UWB circuit 410 is similar to the UWB circuit 310, except that, in the UWB circuit 410, the mixers originally in the receiving circuit 317 are moved out of the receiving circuit 317. In other words, the UWB circuit 410 includes a mixer 413, a mixer 415, and a receiving circuit 417, but the receiving circuit 417 does not include a mixer.

The input terminal of the mixer 413 is coupled to the output terminal of the LNA 312; the output terminal of the mixer 413 is coupled to the input terminal of the receiving circuit 417. The input terminal of the mixer 415 is coupled to the output terminal of the LNA 314; the output terminal of the mixer 415 is coupled to the input terminal of the receiving circuit 417.

In the UWB circuit 410, the control value R2 further corresponds to the mixer 413, and the control value R4 further corresponds to the mixer 415. That is to say, the mixer 413 and the mixer 415 operate according to the control value R2 and the control value R4, respectively. More specifically, the LNA 312 and the mixer 413 are enabled or disabled simultaneously, and the LNA 314 and the mixer 415 are enabled or disabled simultaneously.

Because in the radar detection mode, the LNA 312 and the mixer 413 are both disabled, compared to the embodiment in FIG. 3 (where only the LNA 312 is disabled), the RF signal St is less likely to leak to the receiving circuit 417 (i.e., the isolation between the transmission circuit and the receiving circuit is better), thus the UWB circuit 410 has better performance.

As the operating principles of the mixer 413 and the mixer 415 are well known to people having ordinary skill in the art, further elaboration is omitted for brevity.

Equation (1) is the radar transmission formula, in which Pᵣ is the reception power, Pₜ is the transmission power, Gₜ is the transmitting antenna gain, Gᵣ is the receiving antenna gain, σ is the radar cross-section, R is the distance, and λ is the wavelength.

$${P}_{r} = \frac{{P}_{t} {G}_{t}}{4 π {R}^{2}} * \frac{σ}{4 π {R}^{2}} * \frac{{G}_{r} {λ}^{2}}{4 π} \qquad ( 1 )$$

According to Equation (1), when the frequency f=7987.2 MHz, the gain Gₜ=Gᵣ=2.15 dBi, the radar cross-section σ=0.02, and the distance R=5 m, the path loss

$${L}_{p} = \frac{{P}_{t}}{{P}_{r}} = 10 2.12 dB .$$

Because the UWB circuit 310 and the UWB circuit 410 receive signals through the second link 324 in the radar detection mode, the noise factor has an improvement of 1.5 dB. Compared to the first link 322, under the same link loss, the detection distance will improve from 5 m to 5.45 m. Additionally, compared to the omnidirectional antennas used in the conventional technology, after switching to use the directional antenna 303, the antenna gain G, improves from 2.15 dBi to 5.15 dBi. Therefore, under the same link loss, the corresponding detection distance increases to 6.48 m.

In addition, because there is no switch on the second link 324 (since there is no need to switch between signal reception and signal transmission), in addition to the relatively low link loss, it is also possible to adjust the impedance matching exclusively for the signal reception. Therefore, the noise factor of the second link 324 has an improvement of 1.5 dB compared to the noise factor of the first link 322 (i.e., the sensitivity is increased by 1.5 dB).

Generally speaking, the regulations of UWB (e.g., the Federal Communications Commission (FCC) and the European Telecommunications Standards Institute (ETSI)) have a requirement for the equivalent isotropic radiated power (EIRP) to be less than −41.3 dBm/MHz regarding the transmission power. Therefore, even if the gain of the transmitting antenna increases, the transmission distance still cannot be improved due to regulatory restrictions. On the contrary, since the regulations do not limit the reception power, the present invention increases the transmission distance by increasing the antenna gain of the second link 324 without being restricted by the regulations.

In summary, the UWB circuit 310 can operate in the radar detection mode or the UWB ranging mode, and the radar detection mode and the UWB ranging mode share the transmission circuit 316 and the receiving circuit 317, thus reducing the circuit area and saving circuit costs. In addition, because the UWB circuit 310 receives signals through different antennas in the two modes, the UWB circuit 310 performs better in both modes.

Note that the shape, size, and ratio of any element in the disclosed figures are exemplary for understanding, not for limiting the scope of this invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An ultra-wideband (UWB) circuit, comprising:
a first pin;
a second pin;
a control register storing a plurality of control values;
a baseband circuit coupled to the control register and configured to set the plurality of control values;
a switch coupled to the first pin;
a transmission circuit coupled to the control register and the switch and configured to operate according to one of the plurality of control values;
a receiving circuit coupled to the control register and configured to operate according to one of the plurality of control values;
a first low noise amplifier (LNA) coupled to the switch and the receiving circuit; and
a second LNA coupled to the second pin and the receiving circuit.

2. The UWB circuit of claim 1 further comprising:
a first mixer coupled between the first LNA and the receiving circuit; and
a second mixer coupled between the second LNA and the receiving circuit.

3. The UWB circuit of claim 2, wherein when the UWB circuit operates in a radar detection mode, the baseband circuit, through the control register, enables the transmission circuit, the receiving circuit, the second LNA, and the second mixer, disables the first LNA and the first mixer, and controls the switch to switch to the transmission circuit.

4. The UWB circuit of claim 3, wherein the first pin is coupled to an omnidirectional antenna, the second pin is coupled to a directional antenna, and the UWB circuit transmits signals through the omnidirectional antenna and receives signals through the directional antenna.

5. The UWB circuit of claim 2, wherein when the UWB circuit operates in a UWB ranging mode, the baseband circuit, through the control register, enables the transmission circuit, the receiving circuit, the first LNA, and the first mixer, disables the second LNA and the second mixer, and controls the switch to switch to the transmission circuit before controlling the switch to switch to the receiving circuit.

6. The UWB circuit of claim 5, wherein the first pin is coupled to an omnidirectional antenna, the second pin is coupled to a directional antenna, and the UWB circuit transmits and receives signals through the omnidirectional antenna.

7. The UWB circuit of claim 1, wherein the first pin is coupled to an omnidirectional antenna, and the second pin is coupled to a directional antenna.

8. The UWB circuit of claim 7, wherein when the UWB circuit operates in a radar detection mode, the UWB circuit transmits a first signal through the omnidirectional antenna and receives a second signal through the directional antenna.

9. The UWB circuit of claim 8, wherein through the control register, the baseband circuit enables the transmission circuit, the receiving circuit, and the second LNA, disables the first LNA, and controls the switch to switch to the transmission circuit.

10. The UWB circuit of claim 7, wherein when the UWB circuit operates in a UWB ranging mode, the UWB circuit transmits and receives signals through the omnidirectional antenna.

11. The UWB circuit of claim 10, wherein through the control register, the baseband circuit enables the transmission circuit, the receiving circuit, and the first LNA, disables the second LNA, and controls the switch to switch to the transmission circuit before controlling the switch to switch to the receiving circuit.
